(19) United States
(12) Patent Application Publication
(10) Pub. No.: US 2017/0140407 A1
(43) Pub. Date: May 18, 2017

(54) Distributed Computing System

(71) Applicant: Wal-Mart Stores, Inc., Bentonville, AR (US)

(72) Inventors: Rahul Chowdhury, Rogers, AR (US); Willie Montgomery, III, Rogers, AR (US)

(21) Appl. No.: 15/347,862

(22) Filed: Nov. 10, 2016

Related U.S. Application Data
(60) Provisional application No. 62/258,179, filed on Nov. 20, 2015.
(60) Provisional application No. 62/255,126, filed on Nov. 13, 2015.

(51) Int. Cl. G06Q 30/02; G06F 17/30

(52) U.S. Cl. CPC G06Q 30/0206; G06F 17/3087

(57) ABSTRACT

The present disclosure deals with a method, system and computer readable medium to calculate suggested data, distribute the suggested data over a distributed computing system and update terminals the new suggested data. The application gathers data from shared folders on the central server and calculates the suggested data. The application pushes all the calculated data into a centrally located database. A second application retrieves the calculated data in spreadsheet form. A data is updated according to preferences and stored the in the centrally located database. The second application transmits the suggested data to select computing systems. The computing system updates the terminals with the new suggested data.

This application is claims priority to U.S. Provisional Application No. 62/255,126 filed on Nov. 13, 2015, and U.S. Provisional Application No. 62/258,179 filed on Nov. 20, 2015, the content of each is hereby incorporated by reference in its entirety.

### BACKGROUND

Large corporations typical have geographically distributed computing systems.

Maintaining consistency of data and execution across these distributed computing systems can be challenging, particularly when data needs to be sent to select computing systems and the computing systems are dynamically updated based on the data.

### BRIEF DESCRIPTION OF DRAWINGS

Illustrative embodiments are shown by way of example in the accompanying drawings and should not be considered as a limitation of the present disclosure:

FIG. 1 illustrates an exemplary distributed environment including communicatively coupled computing systems in accordance with exemplary embodiments of the present disclosure;

FIG. 2 is a block diagram of an example computing device for implementing exemplary embodiments of the present disclosure;

FIG. 3 is a block diagram that illustrates example data flow for providing suggested data over a distributed computing system in accordance with exemplary embodiments of the present disclosure;

FIG. 4 is a flowchart illustrating generation of suggested data according to exemplary embodiments of the present disclosure;

FIG. 5 is a graph illustrating different example scenarios for generation of suggested data according to exemplary embodiments of the present disclosure;

FIG. 6 is a graph illustrating boundaries for generation of suggested data according to exemplary embodiments of the present disclosure;

FIG. 7 is a graph illustrating generation of suggested data using margin, profit, sales and cost data according to exemplary embodiments of the present disclosure;

FIG. 8 illustrates a sample graphical user interface (GUI) for interfacing with embodiments of a strategic price recommendation tool;

FIG. 9 illustrates an example GUI for displaying suggested pricing data;

FIG. 10 illustrates an example GUI to facilitate analysis for generating suggested pricing data according to exemplary embodiments; and

FIG. 11 is a flowchart illustrating a process for distributing suggested data over a distributed computing system and updating select computing systems based on the suggested data.

### DETAILED DESCRIPTION

Described in detail herein are methods, systems, and computer-readable media associated with generation and sequenced distribution of suggested data over a distributed computing system.

In accordance with embodiments of the present disclosure, a computing system in a distributed computing environment can include an application located on one or more centrally located servers that executes periodically based on, for example, a specified period of time. Embodiments of the application can retrieve current data being utilized by other computing systems in the distributed computer environment to facilitate operation of the other computing systems, and can generate suggested data to be utilized by the other computing systems in place of the current data to alter an operation of the other computing systems.

In accordance with embodiments of the present disclosure, a distributed computing system may include data storage devices including first and second data sources, which may be embodied as or in one or more non-transitory computer-readable media, a first computing system may include a first server having a first processor communicatively coupled to the one or more data storage devices through a first network to facilitate communication between the processor and the first data source and between the processor and the second data source.

In exemplary embodiments, the server may be programmed to execute an automated batch file to query the first data source for current data associated with an object, generate suggested data based on the current data, and transmit the suggested data to the second data source. In exemplary embodiments, a second computing system may include a second server having a second processor communicatively coupled to the one or more data storage devices through a second network to facilitate communication between the second processor and the second data source.

In exemplary embodiments, the second server may be programmed to query the second data source for the suggested data, and transmit the suggested data to select additional computing systems distributed across the different geographic locations through a third network, wherein the second computing system replaces the current data with the suggested data based on transmission of the suggested data to the select additional computing system.

In exemplary embodiments, the suggested data may be a suggested price for a product. In exemplary embodiments, the current data may include market rules, current price and price gap goals. In exemplary embodiments, the market rules may include a country, a format, a category, or a zone.

In exemplary embodiments, wherein calculating the suggested price for a product may include, calculating price elasticity of the product based on the current data, calculating, a revenue of the product based on the current data and the calculated price elasticity, calculating a profit of the product based on the current data and the calculated price elasticity calculating a lower limit price and an upper limit price based on the revenue, the profit and the current data and calculating a new price for the product in-between the lower limit price and the upper limit price.

The following description is presented to enable any person skilled in the art to generate and distribute suggested data over a distributed computing system. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that example embodiments of the present disclosure may be practiced without the use of these specific details. In other instances, well-known structures and processes are shown in block diagram form in order not to obscure the description of example embodiments with unnecessary detail. Thus, the present disclosure is not intended to be limited to the embodiments shown, but is to be accorded the widest scope consistent with the principles and features disclosed herein.

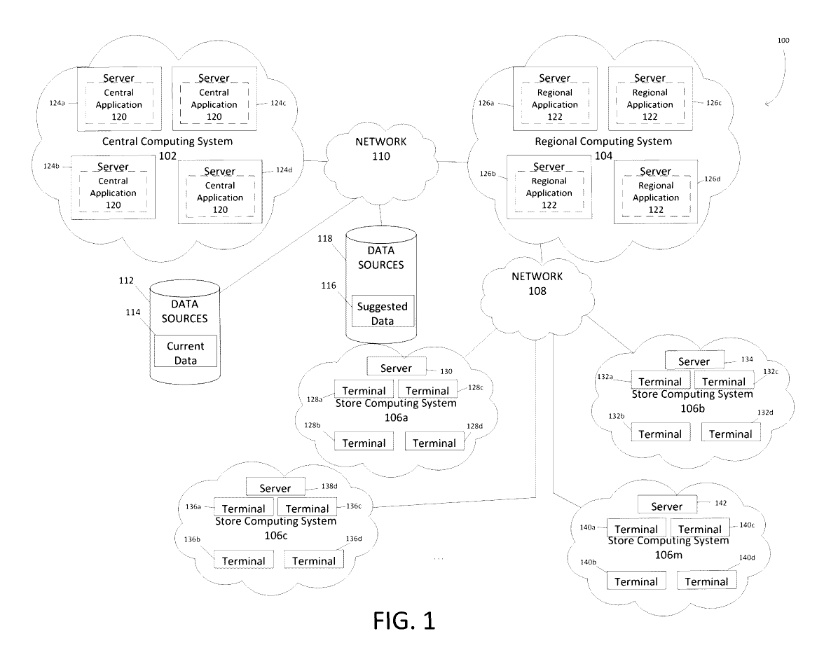

FIG. 1 illustrates a distributed computing system 100 including a central (first) computing system 102, a regional (second) computing system 104, a plurality of store (additional) computing systems 106a-m, data sources 112 and 118. In exemplary embodiments, the central computing system 102 is in communication with the regional computing system 104 and data sources 112, 118 via a communications network 110. In exemplary embodiments, the regional computing system 104 may be in communication with the plurality of store computing systems 106a-m via a communications network 108. In other embodiments, the central computing system 102, the regional computing system 104, the plurality of store computing systems 106a-m, and data sources 112 and 118 may be in communication via the same communication network. The communications networks 108 and 110 can include different components routers, switches, hubs, and/or other suitable components which can be used to form different routes between the central computing system 102 and the regional computing system 104 and between the regional computing system 104 and the store computing systems 106a-m. In exemplary embodiments, the central computing system 102 is includes servers 124a-d. In exemplary embodiments, the regional computing system 104 includes servers 126a-d. In exemplary embodiments the plurality of store computing systems 106a-m include servers 130, 134, 138, 142 and/or terminals 128a-d, 132a-d, 136a-d, 140a-d.

The data sources 112 and 118 may store information/data, as described herein. For example, the data sources 112 may include a current data source 114. In exemplary embodiments the current data source 114 can include a group of shared folders stored in one or more directories maintained by the data source, where one or more current data files are stored in the folders. The current data source 114 can store product information including current pricing, market rules, and price gap goals. In exemplary embodiments, data sources 118 may include a suggested data 116. In exemplary embodiments, the suggested data 116 can be stored in a database in the suggested data source 118. In exemplary embodiments, the suggested data source 118 can store suggested data generated by an operation of the central computing system and can include category description, item number, country, store banner, zone, item class, current price, current cost, current margin, lower limit price, upper limit price, suggested (optimum) price, price gap at current price, price gap at suggested price, price gap goal, and adjusted price.

In an example embodiment, one or more portions of communications network 108 and 110 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The central computing system 102 can be configured to execute one or more instances of an application 120 to facilitate retrieval of product data (e.g., from the current data source), generation of suggested price data for products based on the retrieved data, and pushing the new suggested price data into one or more data structures stored in one or more data sources (e.g., the suggested data database). In exemplary embodiments, an operation of the central application 120 can be distributed across the servers 124a-d such that each server is performing one or more functions and/or operations of the central application 120. In exemplary embodiments, an instance of the central application 120 can be implemented by each server such that functions and/or operations of the application can be formed by a single server.

The regional computing system 104 can be configured to execute one or more instances of a regional application 122 to facilitate retrieval of suggested price data from the one or more data structures (e.g., suggested data source 118), editing the suggested price data in the one or more data structures, and selectively transmitting the updated data structure to computing systems located in different geographic locations. In exemplary embodiments, an operation of the regional application 122 can be distributed across the servers 126a-d such that each server is performing one or more functions and/or operations of the regional application 122. In exemplary embodiments, an automated batch file may be executed based on a predetermined period of time. The automated batch file may include instructions to launch the central application 120. In an exemplary operation, upon execution of the central application 120 by the automated batch file, the central application 120 may retrieve current data. For example, the central application 120 can retrieve the current data from current data files stored in the current data source 114. The current product data can include, but is not limited to current pricing for products, market rules, and price gap goals. In exemplary embodiments, market rules can be specified according to one or more parameters, such as country, format, category and zone. The central application 120 may generate suggested price data based on the current data and can transmit the suggested data to the data source 118. In exemplary embodiments, the automated batch file may be an automated script file, .bat file, .cmd file or .btm file. In exemplary embodiments, the automated batch file may be executed based on a predetermined period of time. In other embodiments, the automated batch file may be executed based on data updates in the current data source 114.

In some embodiments, the central application 120 can determine the effect suggested data can have on affinity products. In exemplary embodiments, affinity products can be products often sold together with the product for which a suggested pricing data is generated. The central application 120 may calculate that the suggested pricing data will not adversely affect the sale of the affinity products.

In some embodiments, the central application 120 may suggest the price for any linked products. For example, if one flavor of ice cream for a specific brand has a new suggested (optimal) price, all the flavors of the same brand of ice cream will have the same newly suggested (optimal) price.

In some embodiments, the central application 120 may subtract taxes from the current prices before generating suggested pricing data. For example, in certain countries tax is included in listed prices of products. To calculate a suggested price, the appropriate taxes can first be taken out of the current price. The central application 120 can omit this step in jurisdictions where tax is not included in the listed price of products.

Once the central application 120 generates the suggested data and the suggested data is stored in the suggested data source 118, the regional computing system can execute the regional application 122 to query the suggested data database 116 and retrieve the suggested data. In exemplary embodiments, the suggested data may include, category description, item number, country, store banner, zone, item class, current price, current cost, current margin, lower limit price, upper limit price, optimum price, price gap at current price, price gap at suggested price, price gap goal, and adjusted price. In some embodiments, the suggested price data can be modified at the regional computing system based on requirements associated with the store computing systems 106a-m. The regional computing system can transmit the suggested price data to one or more selected store computing systems 106a-m distributed across the different geographic locations. For example, the regional application may be executed to select to send the suggested (optimal) pricing data to computing system 106a, 106b and 106f. In exemplary embodiments, the computing systems may update the POS system with the respective suggested (optimal) pricing data. In exemplary embodiments, a designated user may select which stores to transmit the suggested data. In exemplary embodiments, the regional computing system may transmit the suggested data to the respective store computing systems 106a-m to replace the current data with the suggested data in the Point Of Sale (POS) systems located in the stores.

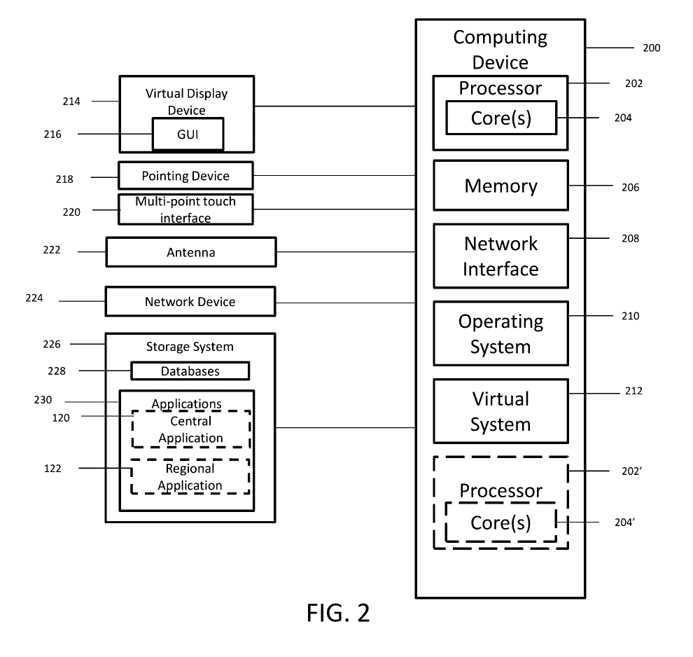

FIG. 2 is a block diagram of an example computing device 200 that may be used to implement exemplary embodiments of the present disclosure. In exemplary embodiments, the computing device 200 may implement embodiments of central computing system 102, regional computing system 104, and the store computing systems 106a-m. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 206 included in the computing system 200 may store computer-readable and computer-executable instructions or software (e.g., applications 230) for implementing exemplary operations of the computing device 200. The computing device 200 also includes configurable and/or programmable processor 202 and associated core(s) 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for implementing exemplary embodiments of the present disclosure. Processor 202 and processor(s) 202′ may each be a single core processor or multiple core (204 and 204′) processor.

Virtualization may be employed in the computing system 200 so that infrastructure and resources in the computing system 100 may be shared dynamically. A virtual machine 212 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

A user may interact with the computing system 200 through a visual display device 214, such as a computer monitor, which may display one or more graphical user interfaces 216, multi touch interface 220, and a pointing device 218.

The computing device 200 may also include one or more storage devices 226, such as a hard-drive, CD-ROM, or other computer readable media, for storing data and computer-readable instructions and/or software that implement exemplary embodiments of the present disclosure (e.g., applications). As one example, when the computing device is implemented as one of the servers 124a-d of the central computing system 102 (FIG. 1), the one or more storage devices 226 can store the central application 120, which can be executed by the processor 202 of the computer device 200. As another example, when the computing device 200 is implemented as one of the servers 126a-d of the regional computing system 104, the one or more storage device 226 can store the regional application 122, which can be executed by the processor 202. The one or more databases 228 can store any suitable information required to implement exemplary embodiments. For example, exemplary storage device 226 can include one or more databases 228 for storing information, such as current product data including current pricing, market rules, and price gap goals and suggested data for storing the calculated new pricing suggested data. The databases 128 may be updated manually or automatically at any suitable time to add, delete, and/or update one or more data items in the databases.

The computing device 200 can include a network interface 208 configured to interface via one or more network devices 224 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 222 to facilitate wireless communication (e.g., via the network interface) between the computing device 200 and a network and/or between the computing device 200 and other computing devices. The network interface 208 may include a built-in network adapter, network interface card, PCMCIA network card, card bus network adapter, wireless network adapter, USB network adapter, modem or any other device suitable for interfacing the computing device 200 to any type of network capable of communication and performing the operations described herein.

The computing device 200 may run any operating system 210, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 200 and performing the operations described herein. In exemplary embodiments, the operating system 210 may be run in native mode or emulated mode. In an exemplary embodiment, the operating system 210 may be run on one or more cloud machine instances.

The servers and the terminals of the computing systems shown in FIG. 1 can include more or fewer components than the computing device 200 shown in FIG. 2.

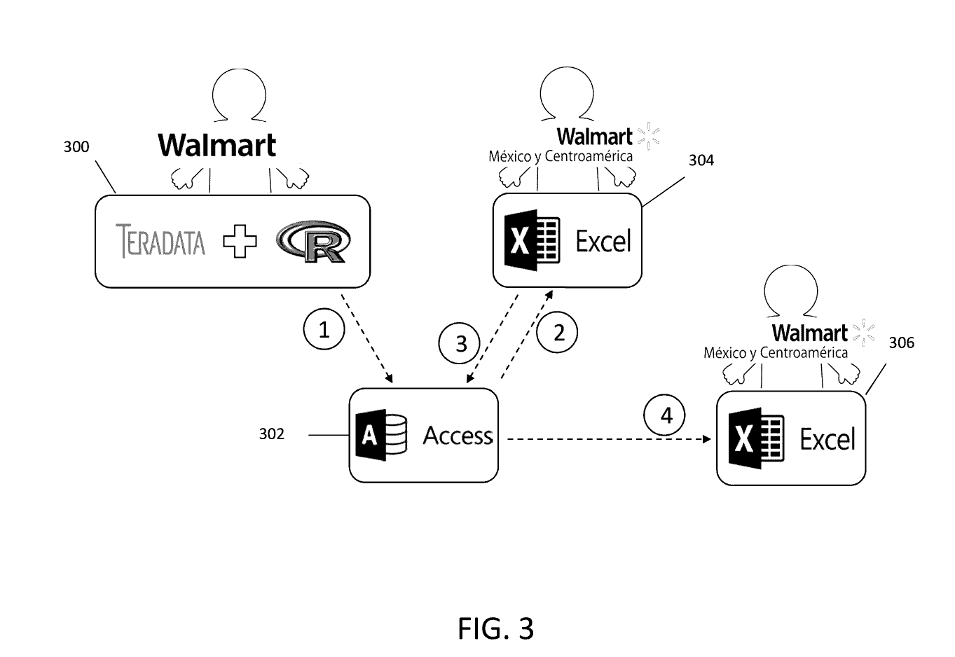

FIG. 3 is a block diagram that illustrates example data flow for providing suggested data over a distributed computing system in accordance with exemplary embodiments of the present disclosure. In exemplary embodiments, an automated batch file may be executed. The automated batch file may include instructions to launch the central application 120. In exemplary embodiments, the automated batch may be executed based on a predetermined period of time. In other embodiments, the automated batch may be executed based on data updates in the current data source 114. The central application 120 may retrieve the current data from the current data source. In exemplary embodiments, the central application 120 may use Teradata to extract the current data from shared folders located in the current data source 114. The central application 120 calculates suggested (optimal) pricing data based on the current product data. In exemplary embodiments, the central application 120 may use R code to execute the calculation of the suggested (optimal) price data. The central application 120 may push the calculated suggested (optimal) price data into the suggested data source 118. In exemplary embodiments, the suggested data source 118 may be implemented with a Microsoft Access database. The regional application 122, located on the regional computing system 104 may retrieve the suggested (optimal) pricing data from the suggested data database 116. The regional application 122 may display the suggested (optimal) pricing data in, for example, a Microsoft Excel spreadsheet. In exemplary embodiments, the suggested (optimal) price data can be modified at the regional computing system and may be updated in the suggested (optimal) price data source 118. The regional application 122, may transmit the updated suggested (optimal) price data to select store computing systems 106a-m. For example, the suggested (optimal) price data may only be transmitted to computing systems 106a, 106d, and 106f. The store computing systems 106a-m may receive the suggested (optimal) price data. The store computing systems 106a-m may replace the old price data with the received suggested (optimal) price data.

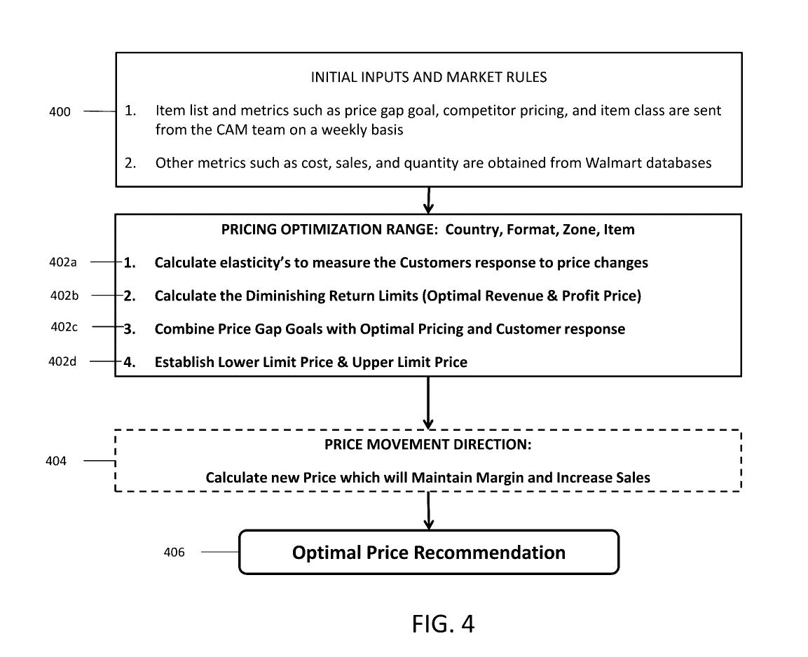

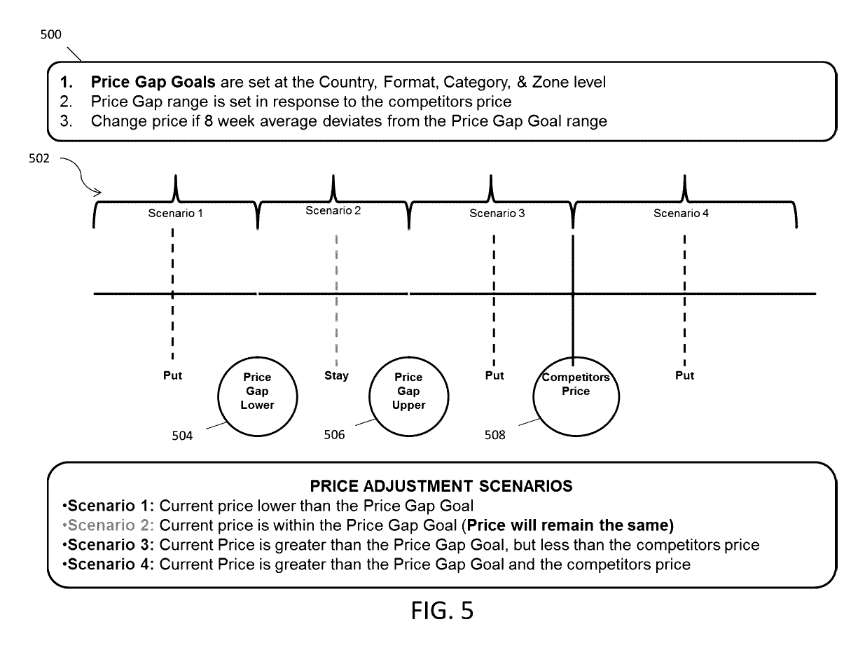

FIG. 4 is a flowchart illustrating generation of suggested data according to exemplary embodiments of the present disclosure. FIGS. 5-8 will be also be referenced to help illustrate the flowchart described in FIG. 4. In exemplary embodiments, the suggested data may be suggested (optimal) price data. In exemplary embodiments, in operation 400, the central application 120 retrieves the current data from the current data source 114. In exemplary embodiments, the current data may include item list and metrics, such as price gap goal, competitor pricing, and item classes (KVI, A, B, C) from the regional system periodically (e.g., once a week). The central application 120 can also retrieve additional metrics, such as cost, sales, and quantity from the first data source.

As an example, in graph 502 shown in FIG. 5, price gap goals are set according to the market rules, e.g. country, format, category and zone. The price gap range can be set in response to competitor's price. The graph 502 illustrated in FIG. 5 illustrates different scenarios of the price gap goals and price gap range based on the competitor's price. The suggested (optimal) price should fall within the price gap goals. For example in Scenario 1, the price is lower than the lower and upper price gap goals 504, 506 and lower than the competitor's price 508 consequently the central computing system can execute the application 120 to suggest a price that lies within the price gap goals. In Scenario 2, the price is within the lower and upper price gap goals 504, 506 consequently the central computing system does not suggest a price change. In Scenario 3, the price is greater than the lower and upper price gap goal 504, 506, but less than the competitor's price 508 consequently the price should be changed to the lie within the price gap goals. In Scenario 4, the price is greater than the competitor's price 508 and greater than the lower and upper price gap goals 504, 506 consequently the central computing system can execute the application 120 to suggest a price change that lies within the price gap goals.

Referring to FIG. 4, in operation 402a, the central application 120 calculates a price (optimization) range. The central application 120 calculates the price elasticity to predict the customer's response to price changes. In exemplary embodiments, elasticity relates to responsiveness of customer demand for a product to change in an independent variable. In exemplary embodiments, the price elasticity is an expected proportional change in a quantity of sales of a product to a given proportional change in price of the product. In operation 402b, the central application 120 calculates the diminishing return limits. The diminishing return limits may indicate a price range at which the product is predicted to produce the optimal revenue and optimal profit price. In exemplary embodiments, Equation 1 is applied to calculate a price for a product that will result in a maximum (optimal) profit.

P₂=((P₁−*(ME−1)/2*(ME))+C (1)

In exemplary embodiments, P₂ represents the suggested (optimal) price, P₁ represents the current price, C represents the current cost, ME represents Margin Elasticity and PE represents the Price Elasticity. In exemplary embodiments margin elasticity relates to expected proportional change in quantity to a given proportional change in margin.

In exemplary embodiments, Equation 2 is applied to calculate the price of a product resulting in a maximum (optimal) revenue.

P₂=P₁(PE−1)/(2*PE) (2)

In exemplary embodiments, P₂ represents the suggested (optimal) price, P₁ represents the current price, and PE represents the Price Elasticity.

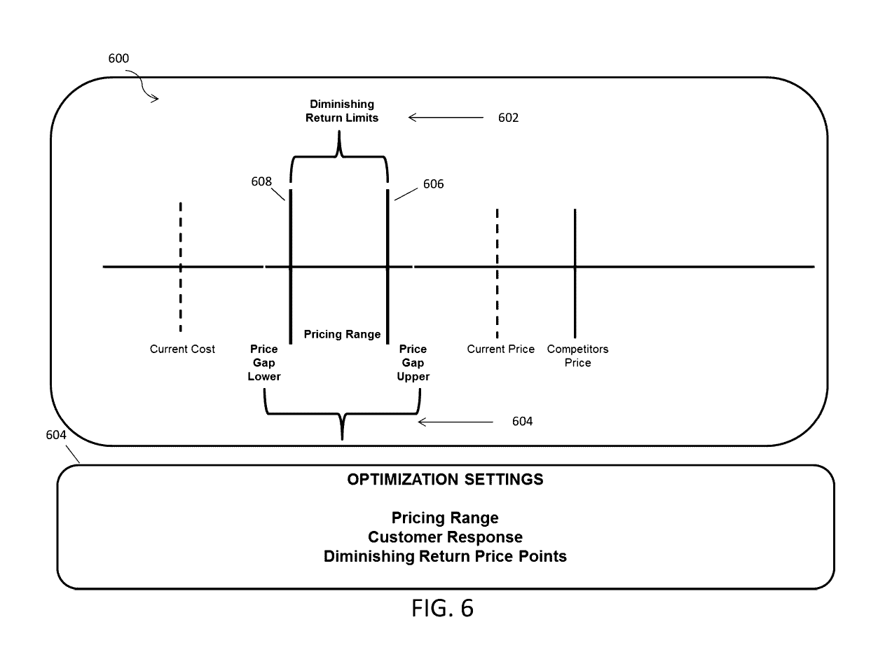

As an example, in graph 600 shown in FIG. 6, diminishing return limits 602 have been calculated to be within the price gap goal limits 604. In exemplary embodiments, the price gap goal limits are absolute limits. In exemplary embodiments, the maximum (optimal) profit 606 represents one limit of the diminishing return limits and the maximum (optimal) revenue 608 represents the other limit of the diminishing return limits. In the present example, since the diminishing return limits are within the price gap goals, the suggested maximum (optimal) price may lie anywhere in between the diminishing return limits. In exemplary embodiments, the diminishing return limits 602 are calculated based on the price gap goal range 604, and price elasticity.

Referring again to FIG. 4, in operation 402c, the central application 120 combines the price gap goal range with the optimal pricing and the predicted customer response estimated by the elasticity. In operation 402d, the central application 120 establishes a lower limit price and an upper limit price. The lower and upper limit prices are based on the calculated optimal revenue, optimal profit price, price elasticity, and price gap goals. In exemplary embodiments, the suggested (optimal) price may be within the lower limit price and upper limit price.

In exemplary embodiments, in operation 404, the central application 120 calculates a new suggested (optimal) price which is expected to maintain margins and increase sales. In exemplary embodiments, the suggested (optimal) price will be within the lower limit price and upper limit price.

In exemplary embodiments, the suggested (optimal) price may be calculated using the following conditional logic.

IF(PE<−1 AND ME<−1)OR(PE>−1 AND ME>−1)THEN New Price=(Output of Max revenue+Output of Max margin)/2
ELSE IF PE<−1 THEN New Price=Output of Max Revenue
ELSE New Price=Output of Max margin

In exemplary embodiments, PE represents price elasticity and ME represents margin elasticity.

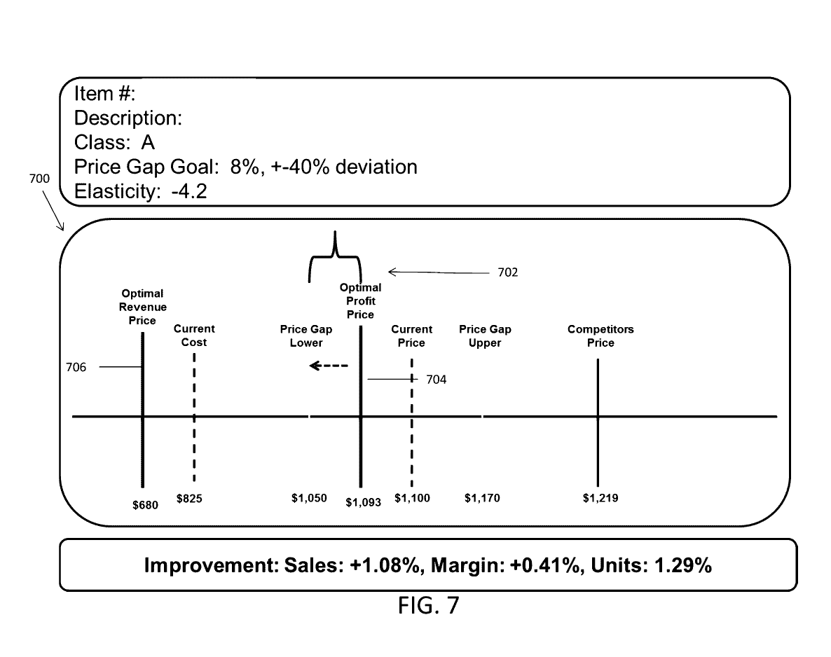

Referring to FIG. 4, in operation 406, a suggested (optimal) price is provided. For example, the graph 700 shown FIG. 7, illustrates the product information after the newly calculated suggested (optimal) price range of the suggested (optimal) price. In this example, the maximum (optimal) profit price 704 is greater than the lower price gap goal limit and less than the upper price gap goal limit. In contrast, the maximum (optimal) revenue price 706 is less than the lower price gap goal limit and less than the upper price gap goal limit. Consequently, since the price gap goal limits are absolute limits, and the maximum (optimal) revenue price lies outside the price gap goal limits, the suggested (optimal) price can only lie within the range 702 of lower price gap limit and the maximum (optimal) price.

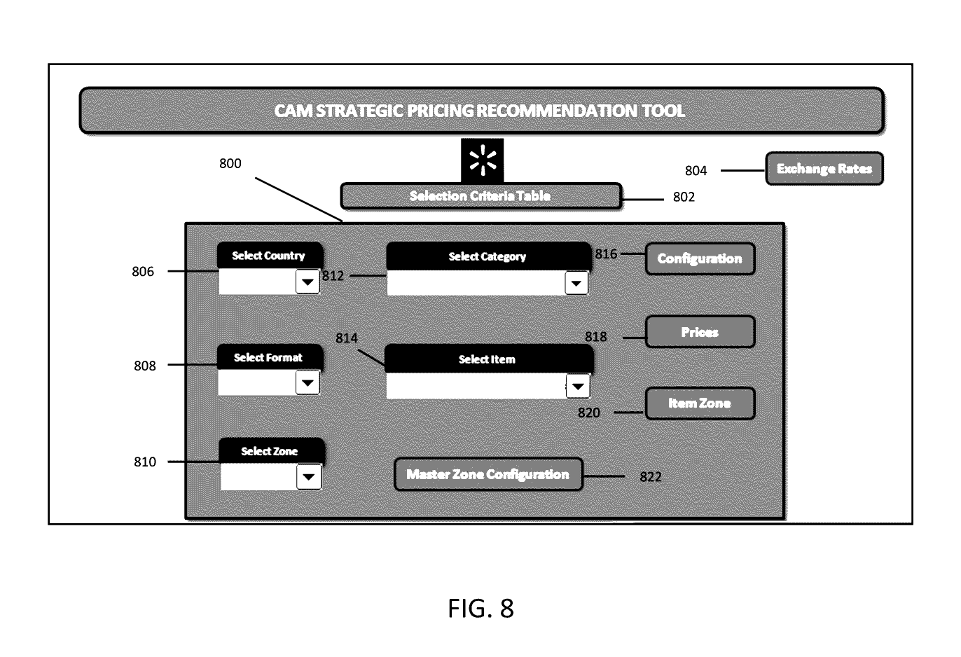

FIG. 8 illustrates a sample graphical user interface (GUI) for interfacing with the strategic price recommendation tool. In exemplary embodiments, the strategic price recommendation tool will provide the interface to generate the suggested data. In exemplary embodiments, the GUI may include a selection area 800 to configure the selection criteria table 802. The selection area 800 may include dropdown selection menus for selecting a country 806, format 808, zone 810, selecting a category 812, and selecting an item 814. The GUI may also include buttons to change the configuration. The GUI may include a master zone configuration button 822, configuration button 816, prices button 818, and an item zone button 820. In exemplary embodiments, the GUI may also include a button to configure the exchange rates 804.

In exemplary embodiments, as a non-limiting example, the central application 120 may calculate a suggested (optimal) price for 3400 products. In exemplary embodiments, the central application 120 may select up to a specified number of products, e.g., 400 out of 3400 products, for which the price can be adjusted. In exemplary embodiments, the central application 120 may select the 400 products that may produce the maximum difference in (optimal) revenue and maximum difference (optimal) profit while remaining within the price gap goals, after adjustment to the suggested (optimal) price. To determine if a product will be selected for a price adjustment based on the suggested (optimal) price, the central application 120 can first calculate the maximum profit of the product using the following equation.

$$Maximize Profit \text{:} {\sum }_{i}^{I} ( {p}_{i} - {c}_{i} ) ⌈ {q}_{i} {x}_{i} + {q}_{i}^{′} ( 1 - {x}_{i} ) ⌉ - {\sum }_{i}^{I} {q}_{i} ( {p}_{i} - {c}_{i} ) \qquad ( 3 )$$

In Equation 3, pᵢ represents price of a product, cᵢ represents cost of the product, qᵢ represents new average quantity of the product and q′ᵢ represents current average quantity of the product. In exemplary embodiments, the maximum profit can represent the maximum potential difference between the profit at the current prices and the profit at the suggested prices, and can be calculated by taking the difference of the current profit (shown as the second summation element in Equation 3) and new profit based on the newly suggested (optimal) price (shown as the first summation element in Equation 3).

The central application 120 can next count how many products have been selected for a price adjustment. In exemplary embodiments, only a specified number N of products can be selected to be changed, e.g., only up to 400 products can be selected for a price adjustment. The central application 120 will use the following equation to count the number of products that can be selected for a price adjustment.

$$s . 𝓁 . {\sum }_{i}^{I} {x}_{i} \leq N \qquad ( 4 )$$

In Equation 4, N represents the maximum number of price changes.

The central application 120 will next determine if the total revenue is greater than or equal to 0. That is, for selection for price adjustment, the product must have a revenue greater than 0. The central application 120 uses the following equation to determine if the difference between the current revenue and new revenue (the total revenue benefit) is greater than or equal to 0.

$${\sum }_{i}^{I} [ {q}_{i} {x}_{i} + {q}_{i}^{′} ( 1 - {x}_{i} ) ] {p}_{i} - {\sum }_{i}^{I} {q}_{i} {p}_{i} \geq 0 \qquad ( 5 )$$

In Equation 5, pᵢ represents price of a product, qᵢ represents new average quantity of the product and q′ᵢ represents current average quantity of the product. In exemplary embodiments, the current revenue can be calculated using current data (shown as the second summation element in Equation 5) and a predicted new revenue can be calculated using new data based on the newly suggested (optimal) price (shown as the first summation element in Equation 5). The central application 120 will determine whether the total revenue benefit is greater or equal to 0 by calculating the difference between the current revenue and predicted new revenue.

The central application 120 determines if the product's price gap is greater than or equal to the lower limit price gap. For selection for price adjustment the product must have a price gap greater than or equal to the lower limit price gap. The central application 120 will use the following equation to determine if the price gap is greater than or equal to the lower limit price gap.

$$\frac{{Σ}_{i}^{I} [ {q}_{i} {x}_{i} + {q}_{i}^{′} ( 1 - {x}_{i} ) ] {m}_{i} - {Σ}_{i}^{I} [ {q}_{i} {x}_{i} + {q}_{i}^{′} ( 1 - {x}_{i} ) ] {p}_{i}}{{Σ}_{i}^{I} [ {q}_{i} {x}_{i} + {q}_{i}^{′} ( 1 - {x}_{i} ) ] {p}_{i}} \geq L \qquad ( 6 )$$

In Equation 6, pᵢ represents price of a product, cᵢ represents cost of the product, qᵢ represents new average quantity of the product, q′ᵢ represents current average quantity of the product, mᵢ represents market price of the product and L represents the lower limit price gap.

The central application 120 may then assign the product a binary number of 0 or 1. In exemplary embodiments, if the product is selected for price adjustment based on the suggested (optimal) price if assigned a 1. Conversely, the product is assigned a 0 if the product is not selected for price adjustment based on the suggested (optimal) price. The central application 120 uses the following equation to assign the binary number to the product.

x{0,1}∀iεI (7)

In Equation 7, the binary value is assigned to the product within the set constraint iε{1 . . . 3400}.

In other embodiments, the number of products for which the central application 120 calculates a suggested (optimal) price can be greater than or less than 3400.

In other embodiments, the maximum number of products for which the price can be adjusted may be greater than or less than 400.

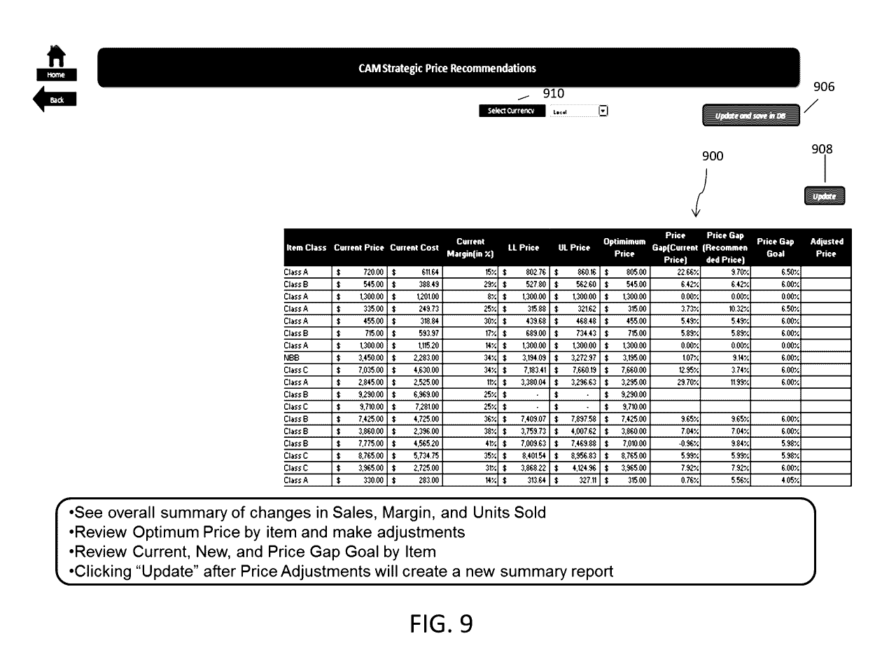

FIG. 9 illustrates an example GUI for displaying the suggested (optimal) pricing information. In exemplary embodiments the GUI may include a chart 900. The cart may include the columns representing, category description, item number, country, store banner, zone, item class, current price, current cost, current margin, lower limit price, upper limit price, optimized price, price gap at current price, price gap at optimized price, price gap goal, and adjusted price. In exemplary embodiments the chart can be ordered based on any of the columns in ascending or descending order. The GUI may also include a summary report 902, summarizing total calculations of a product before and after suggested (optimal) pricing information. The columns of the summary report 902 may include the calculations of, sales, cost, margin, units sold, price position, and price gap. The rows of the summary report 902 may include current, new, growth, incremental. In exemplary embodiments, the current row represents calculations before applying the suggested (optimal) pricing information. The new row indicates the calculations after applying the suggested (optimal) pricing data. In exemplary embodiments, the GUI may display the market rules 904. The market rules may include the country, format, zone, and price gap goal. In exemplary embodiments, the currency may be updated using the select currency dropdown 904. The GUI may also include an update and save button 906 and an update button 908. In exemplary embodiments, the chart may be updated 900 by adjusting the optimum price and/or currency 910. The update button 906 may produce new calculations based on the adjustments. The update and save to database button 908 may produce new calculations based on the adjustments and save the adjustments and new calculations in the suggested data database

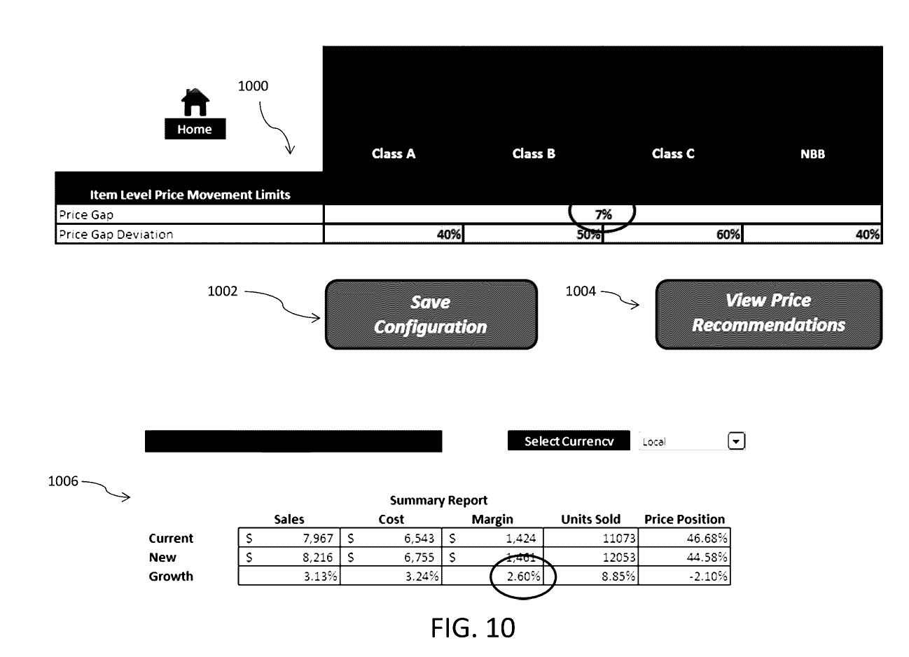

FIG. 10 illustrates an example GUI price gap goal sensitivity analysis according to exemplary embodiments. In exemplary embodiments, the GUI shown in FIG. 10 may provide a chart 1000 reflecting item level price movement limits. The top columns may be populated with the market rules, while the columns below may be populated with the item class. The chart 1000 may display the price gap deviation based on the price gap, the market rules and the item class. In exemplary embodiments, the price gap may be adjusted to update price recommendations. The updated price recommendation based on the adjusted price gap can be viewed using the view price recommendation button 1004. In exemplary embodiments, a summary report 1006 may also be displayed, reflecting calculations based on the adjusted price gap. The columns of the summary report 1006 may include including the calculations of, sales, cost, margin, units sold, price position, and price gap. The rows of the summary report 1006 may include current, new, and growth. In exemplary embodiments, the current row represents calculations before applying the suggested (optimal) pricing information. The new row indicates the calculations after applying the suggested (optimal) pricing information. In exemplary embodiments the growth row reflects the growth comparison between the new and current calculations. In exemplary embodiments, the adjusted price gap can be saved by clicking the save configuration button

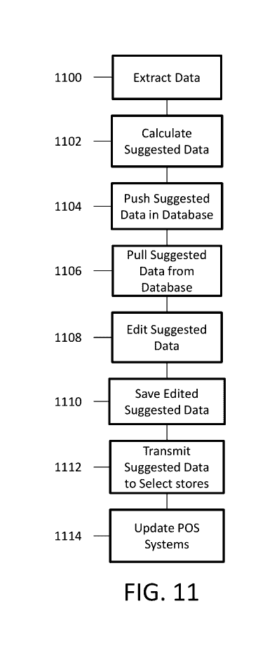

FIG. 11 is a flowchart illustrating providing suggested data over a distributed computing system. In exemplary embodiments in operation 1100 the central application 120 retrieves current product data from the current product data source 114. In exemplary embodiments, the current product data may be stored in shared folders stored on the central computing system 102. In exemplary embodiments, the current product data may be extracted by the optimized equation using Teradata. In operation 1102, the central application 120 calculates a suggested (optimal) pricing data using the current product data. In exemplary embodiments, R code can be used to calculate the suggested (optimal) pricing data.

In exemplary embodiments, in operation 1104 the central application 120 may transmit and store the suggested (optimal) pricing data in a suggested data source 116. In operation 1106, the regional application 122 may pull the suggested (optimal) pricing data from the suggested data database 232. In exemplary embodiments, the regional application 122 may display the suggested (optimal) pricing data in an excel spreadsheet format. In operation 1108, the suggested (optimal) pricing data may be edited in the excel sheet. The changes in the data based on different price settings may be reviewed. In operation 1110, the updated data in the suggested (optimal) pricing data may be saved in the suggested data source 116. In operation 1112, the regional application 122 may transmit the suggested (optimal) pricing data to select stores computing system 106a-m. In exemplary embodiments, the store computing system may be a smart store system. In operation 1114, the smart store system updates the POS systems throughout the store with the suggested (optimal) pricing data.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A distributed computing system comprising:
one or more data storage devices including a non-transitory computer-readable medium storing a first data source and a second data source;
a first computing system including a first server having a first processor communicatively coupled to the one or more data storage devices through a first network to facilitate communication between the processor and the first data source and between the processor and the second data source, the server being programmed to execute an automated batch file to (i) query the first data source for current data associated with an object, (ii) generate suggested data based on the current data, and (iii) transmit the suggested data to the second data source; and
a second computing system including a second server having a second processor communicatively coupled to the one or more data storage devices through a second network to facilitate communication between the second processor and the second data source, the second server being programmed to (i) query the second data source for the suggested data, and (ii) transmit the suggested data to select additional computing systems distributed across the different geographic locations through a third network, wherein the second computing system replaces the current data with the suggested data based on transmission of the suggested data to the select additional computing systems.

2. The system in claim 1, wherein the suggested data is a suggested price for a product.

3. The system in claim 1, wherein the current data includes market rules, current price and price gap goals.

4. The system in claim 3, wherein the market rules include a country, a format, a category, or a zone.

5. They system in claim 4, wherein calculating the suggested price for a product includes, (i) calculating price elasticity of the product based on the current data; (ii) calculating, a revenue of the product based on the current data and the calculated price elasticity; (iii) calculating, a profit of the product based on the current data and the calculated price elasticity; (iv) calculating a lower limit price and an upper limit price based on the revenue, the profit and the current data; and (v) calculating a new price for the product in-between the lower limit price and the upper limit price.

6. The system in claim 5, wherein a point-of-sale (POS) is updated with the suggested price.

7. The system in claim 1, wherein the first and second computing systems are located in different geographic locations.

8. A method performed in a distributed computing system, the method comprising:
querying, in response to receipt of an automated batch file, a first data source for current data associated with an object by a first computing system including a first server having a first processor communicatively coupled to the one or more data storage devices through a first network to facilitate communication between the processor and the first data source;
generating suggested data based on the current data;
transmit the suggested data from the first server to a second data source through the first network;
querying, the second data source for the suggested data by a second computing system including a second server having a second processor communicatively coupled to the one or more data storage devices through a second network to facilitate communication between the second processor and the second data source; and
transmitting the suggested data to select additional computing systems distributed across the different geographic locations through a third network,
wherein the second computing system replaces the current data with the suggested data based on transmission of the suggested data to the select additional computing systems.

9. The method in claim 8, wherein the suggested data is a suggested price for a product.

10. The method in claim 8, wherein the current data includes market rules, current price and price gap goals.

11. The method in claim 10, wherein the market rules include a country, a format, a category, or a zone.

12. They method in claim 11, wherein calculating the suggested price for a product includes, (i) calculating price elasticity of the product based on the current data; (ii) calculating, a revenue of the product based on the current data and the calculated price elasticity; (iii) calculating, a profit of the product based on the current data and the calculated price elasticity; (iv) calculating a lower limit price and an upper limit price based on the revenue, the profit and the current data; and (v) calculating a new price for the product in-between the lower limit price and the upper limit price.

13. The method in claim 11, wherein a point-of-sale (POS) is updated with the suggested price.

14. The method in claim 8, wherein the first and second computing systems are located in different geographic locations.

15. A non-transitory computer readable memory medium storing instructions, wherein the instructions are executable by a processor to:
query, in response to receipt of an automated batch file, a first data source for current data for associated with an object by a first computing system including a first server having a first processor communicatively coupled to the one or more data storage devices through a first network to facilitate communication between the processor and the first data source;
generate suggested data based on the current data;
transmit the suggested data from the first server to a second data source through the first network;
query, the second data source for the suggested data by a second computing system including a second server having a second processor communicatively coupled to the one or more data storage devices through a second network to facilitate communication between the second processor and the second data source; and
transmit the suggested data to select additional computing systems distributed across the different geographic locations through a third network,
wherein the second computing system replaces the current data with the suggested data based on transmission of the suggested data to the select additional computing systems.

16. The non-transitory computer readable memory medium in claim 15, wherein the suggested data is a suggested price for a product.

17. The non-transitory computer readable memory medium in claim 15, wherein the current data includes market rules, current price and price gap goals.

18. The non-transitory computer readable memory medium in claim 17, wherein calculating the suggested price for a product includes, (i) calculating price elasticity of the product based on the current data; (ii) calculating, a revenue of the product based on the current data and the calculated price elasticity; (iii) calculating, a profit of the product based on the current data and the calculated price elasticity; (iv) calculating a lower limit price and an upper limit price based on the revenue, the profit and the current data; and (v) calculating a new price for the product in-between the lower limit price and the upper limit price.

19. The non-transitory computer readable memory medium in claim 18, wherein a point-of-sale (POS) is updated with the suggested price.

20. The non-transitory computer readable memory medium in claim 15, wherein the first and second computing systems are located in different geographic locations.
